(19) United States
(12) Patent Application Publication
(10) Pub. No.: US 2023/0286231 A1
(43) Pub. Date: Sep. 14, 2023

(54) APPARATUS FOR SEALING A HOLE IN A LINING OR WALL

(71) Applicant: Guy VAN DER WALT, Zurich (CH)

(72) Inventor: Guy VAN DER WALT, Zurich (CH)

(21) Appl. No.: 18/012,749

(22) PCT Filed: Jun. 25, 2021
(86) PCT No.: PCT/CH2021/050009

§ 371 Date: Dec. 23, 2022

(30) Foreign Application Priority Data
Jul. 3, 2020 (CH) 0082420

(51) Int. Cl. B29C 73/14; F16B 43/00; F16B 37/14

(52) U.S. Cl. CPC B29C 73/14; F16B 43/001; F16B 37/145

(57) ABSTRACT

The present invention relates to an apparatus (2) for sealing a hole or tear in a wall or lining, the apparatus comprising: a plug element in the form of a planar cover (4) having a threaded shaft (6) extending from a first surface in a direction normal to the first surface; a first planar sealing element (8) having an opening configured to receive the threaded shaft; a second planar sealing element (10) having an opening configured to receive the threaded shaft; a rigid planar clamping element (12) having an opening configured to receive the threaded shaft; and a cap element (14) having a threaded opening configured to receive the threaded shaft; wherein the cap element is further configured, upon rotation of the cap element causing the threaded opening to travel along the threaded shaft towards the planar cover of the plug element, to cause the rigid planar clamping element to apply pressure to the first and second sealing elements and thereby form a seal. Methods for applying the disclosed apparatus and an alternative apparatus using tightening mechanisms other than screw thread are also disclosed.

### FIELD OF INVENTION

The present invention generally relates to apparatus and methods for sealing holes in linings and walls. More specifically, the present invention relates to a modular plug comprising sealing elements and a method for quickly applying the plug to a hole or tear in a lining or wall. The invention is particularly well suited to fast repairs of outdoor above ground swimming pools.

### BACKGROUND

There are many ways of sealing holes and tears in walls and linings; however, they often require a long time for components such as fillings to set or are not watertight. These prior art methods and apparatus, therefore, become inconvenient for repairs of items such as above-ground swimming pools, where the use of the pool is desired to be resumed quickly, and a watertight seal is paramount.

It is within this context that the present invention is provided. The present invention relates to apparatus and methods of application thereof that enable instant, complete sealing of holes or tears in walls or lining and which can be applied within a matter of seconds without the use of glue, tape, patches, putties or a combination thereof.

### SUMMARY

The present invention provides an Apparatus for sealing a hole in a lining or wall and a method for applying the apparatus. The Apparatus is a modular plug having first and second sealing elements configured to be placed either side of a hole or tear and a threaded shaft configured to be inserted through openings in the sealing elements and clamped in place to form a seal. Advantageously, the Apparatus can be applied quickly and easily to form a watertight seal around a hole or tear and is therefore particularly useful and convenient for the repair of above-ground swimming pools and the like.

Thus, according to a first aspect of the present invention, there is provided Apparatus for sealing a hole or tear in a wall or lining, the Apparatus comprising: a plug element in the form of a planar cover having a threaded shaft extending from a first surface in a direction normal to the first surface; a first planar sealing element having an opening configured to receive the threaded shaft; a second planar sealing element having an opening configured to receive the threaded shaft; a rigid planar clamping element having an opening configured to receive the threaded shaft; and a cap element having a threaded opening and configured to receive the threaded shaft; wherein the cap element is further configured, upon rotation of the cap element causing the threaded opening to travel along the threaded shaft towards the planar cover of the plug element, to cause the rigid planar clamping element to apply pressure to the first and second sealing elements and thereby form a seal.

In one embodiment, the first and second planar sealing elements are configured to form a watertight seal over any hole or tear clamped therebetween.

In one embodiment, the first and second planar seals are configured to form a seal over holes and tears between 0.01 and 100 mm in diameter, although larger seals are also possible.

In one embodiment, the plug element, rigid planar clamping element, and cap element are each made of either metal or recyclable plastic.

In one embodiment, the first planar sealing element and second planar sealing element are each made of either rubber or silicone.

In one embodiment, the cap element is a protective cap element and is configured to cover the end of the threaded shaft to avoid injury in case of unexpectedly coming into contact with the apparatus. Furthermore, the cap element may further comprise of an aesthetically pleasing design on its surface. In one embodiment, the cap element has rounded edges.

According to a second aspect of the present invention, there is provided a method of using the apparatus of the first aspect for sealing a hole or tear in a wall or lining, the method comprising the following steps in the following order: (a) inserting the threaded shaft through the opening of the first planar sealing element; (b) inserting the threaded shaft through the hole or tear in the wall or lining; (c) inserting the threaded shaft through the opening of the second planar sealing element; (d) inserting the threaded shaft through the opening of the rigid planar clamping element; (e) screwing the cap element having the threaded opening onto the threaded shaft to exert force on the layers between the planar cover and the cap element.

According to a third aspect of the present invention, there is provided an alternative apparatus for sealing a hole or tear in a wall or lining, the apparatus comprising: a plug element in the form of a planar cover having a shaft extending from a first surface in a direction normal to the first surface; a first planar sealing element having an opening configured to receive the shaft; a second planar sealing element having an opening configured to receive the shaft a rigid planar clamping element having an opening configured to receive the shaft; and a cap element having an opening configured to receive the shaft; wherein the apparatus further comprises a mechanism for tightening and securing the cap element in position on the shaft, thereby causing the planar cover and the rigid planar clamping element to exert force on the layers between to form a seal.

In other words, the apparatus of the third aspect may be tightened and secured to form a seal by a mechanism other than a screw thread. In one embodiment, the alternative tightening mechanism takes the form of a snap fitting, such as one may find in a cable tie.

### BRIEF DESCRIPTION OF THE DRAWINGS

Various embodiments of the invention are disclosed in the following detailed description and accompanying drawings.

FIG. 1 illustrates an example configuration of the Apparatus 2 of the present invention in a component's view, with the components separated and in position to be fitted through a hole or tear to be sealed.

FIG. 2 illustrates an example configuration of a plug element according to the present invention.

FIG. 3 illustrates an example configuration of a cap element according to the present invention.

### DETAILED DESCRIPTION AND PREFERRED EMBODIMENT

The following is a detailed description of the exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practised according to the claims without some or all of these specific details. For the purpose of clarity, technical material that is known in the technical fields related to the invention has not been described in detail so that the invention is not unnecessarily obscured.

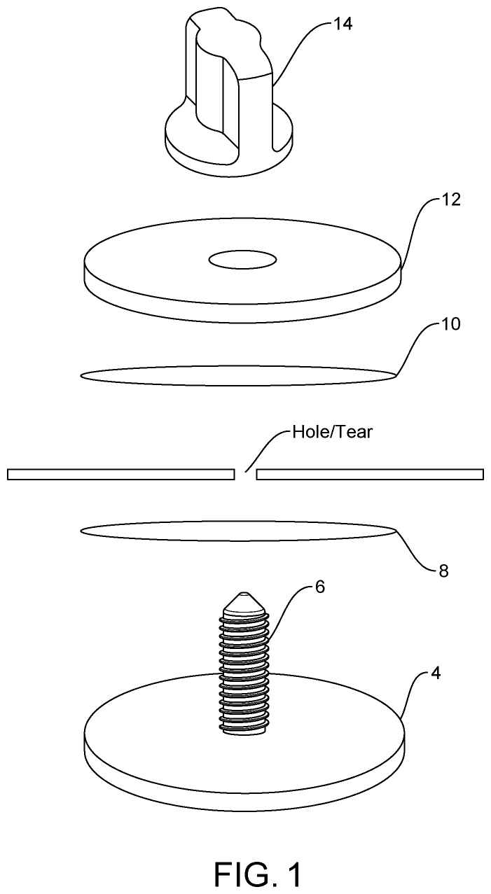

Referring to FIG. 1, an example configuration of the Apparatus 2 of the present invention is shown in a component's view, with the components separated and in position to be fitted through a hole or tear to be sealed.

The components of the Apparatus 2 are in position either side of a compromised lining which is represented by the black line in the middle with an opening that is representing the hole. This may, for example, be the lining of an above ground swimming pool, where repairs are needed fast in order to be able to use the pool again, but critically where the hole needs to be repaired to a point where it is waterproof and will not continue to leak.

As illustrated, in the present example, first 8 and second 10 sealing elements are placed either side of the hole in the lining. These sealing elements are preferably substantially planar to facilitate placement on a wall, and each has an opening therein. Preferably, they are made of semi-flexible material such as rubber or silicone. This is beneficial in several ways. Silicone or rubber is cheap to manufacture using injection mould techniques, and the recyclable nature prevents the end product from negatively affecting the environment. Silicon and rubber are often effective for forming watertight seals however, a skilled person would recognise that many different types of non-porous materials would be suitable for the use of the present invention.

Once the first 8 sealing element and second 10 sealing element have been placed either side of the hole, a plug element formed of a planar cover 4 having a shaft 6 extend centrally from a first surface and normal to its plane is used.

In the present example, the shaft is threaded in order to facilitate tightening between the plug element and elements on the other side of the hole to form a seal by clamping the sealing elements together. However, as will be explained below, methods other than screw thread can be used for tightening.

The planar cover 4 of the plug element is usually flat on the side opposite to the surface having the shaft 6 extending from it, as the cover element is likely to be inserted in a position on the wall where people either swim or pass by, such as the interior or exterior lining wall of an above ground pool. It is therefore advantageous to have the planar cover protrude as little as possible so as to reduce the risk of injury should a person accidentally come into contact with the Apparatus 2. Preferably, the planar cover 4 is at least as wide as the first sealing element 8, and the first surface is substantially flat so as to be able to apply even pressure across the whole of the first sealing element. To furthermore increase its safety, the planar cover 4 may also have rounded edges.

The shaft 6 of the plug element is inserted through the opening in the first 8 sealing element and then through the hole in the lining. Following this, the second sealing element 10 is placed over the extruding shaft 6 and then a rigid planar clamping element 12, having an opening, is placed over the shaft 6. The clamping element 12 effectively plays the role of a washer, providing a flat rigid surface spanning most of the surface or all of the surface of the second sealing element 10. This enables an even pressure to be applied across the second sealing element 10 when force is applied to any part of the clamping element 12. The clamping element 12 could be made out of a rigid plastic but could equally be made of non-rusting or coated metal or another suitable rigid material.

Finally, a cap element 14 having an opening is placed over the clamping element such that the shaft 6 extends through or into the cap element opening, the cap element 14 is tightened and fixed in place so that it applies pressure to the clamping element 12 and thereby forming a watertight seal about the hole by clamping the first and second sealing elements together around it. In the present example, the cap element 14 has a threaded opening which ends within its body. The opening being threaded allows the cap element 14 to be tightened onto the threaded shaft 6 and thereby provides a mechanism for applying force to all of the layers sandwiched between the cap element 14 and the planar cover 4.

However, many other mechanisms for tightening modular elements connected by a shaft extending therethrough are possible and known to the skilled person. One example where no thread would be required on the shaft is if a snap fitting were used, such as the mechanisms used on cable ties. Although such embodiments are not illustrated herein, a skilled person would recognise that any such mechanism falling within the spirit and scope of the claims is envisaged by the present disclosure.

Furthermore, although a cap element is described and illustrated herein as being an actual cap that covers the end of the shaft 6, it should be recognized that the cap element may alternatively take forms where it does not cover the end of the shaft 6 which instead would extend straight through such as a wing nut configuration.

The cap element of the present invention may also comprise of further features such as rounded edges for safety and aesthetic designs thereon. This is advantageous because if the Apparatus 2 is used to repair a hole or tear in an above ground swimming pool lining wall, the cap element will likely be visible from inside or outside the pool, depending on which direction the planar cover 4 is inserted through said hole, and the hole sealed when the cap element 14 is fastened onto the shaft 6. Rounded edges thereby increase the safety of the cap element and the design would prevent the repair from being aesthetically unappealing to users.

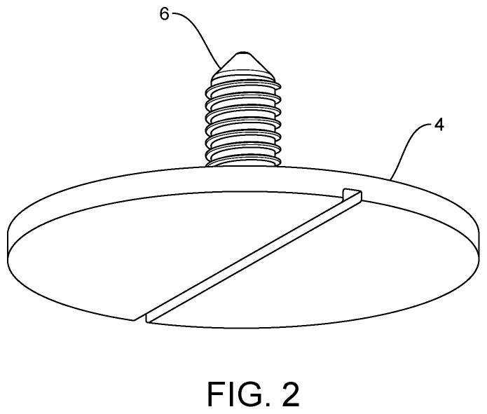

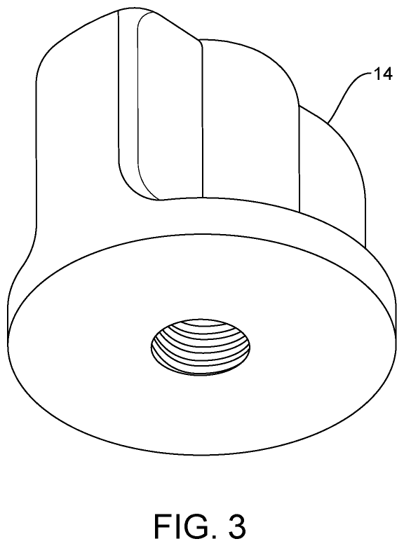

Referring to FIGS. 2 and 3, example configurations of the plug element and cap element are shown. The technical features thereof are as described above in relation to FIG. 1.

### LIST OF REFERENCE NUMERALS

Apparatus (2), Planar cover (4), Threaded shaft (6), First planar sealing element (8), Second planar sealing element (10), Rigid planar clamping element (12), Cap element (14)

### CONCLUSION

The disclosed embodiments are illustrative, not restrictive. While specific configurations of the apparatus and methods for sealing a hole in a wall or lining have been described in a specific manner referring to the illustrated embodiments, it is understood that the present invention can be applied to a wide variety of sealing solutions which fit within the scope and spirit of the claims. There are many alternative ways of implementing the invention.

What is claimed is:

1. Apparatus (2) for sealing a hole in a wall or lining, the apparatus comprising:
a. a plug element in the form of a planar cover (4) having a threaded shaft (6) extending from a first surface in a direction normal to the first surface;
b. a first planar sealing element (8) having an opening configured to receive the threaded shaft;
c. a second planar sealing element (10) having an opening configured to receive the threaded shaft;
d. a rigid planar clamping element (12) having an opening configured to receive the threaded shaft; and
e. a cap element (14) having a threaded opening configured to receive the threaded shaft;
f. wherein the cap element (14) is further configured, upon rotation of the cap element (14) causing the threaded opening to travel along the threaded shaft (6) towards the planar cover (4) of the plug element, to cause the rigid planar clamping element (12) to apply force to the first (8) and second (10) sealing elements and thereby form a watertight seal.

2. Apparatus according to claim 1, wherein the first (8) and second (10) planar sealing elements are configured to form a watertight seal over any hole or opening clamped therebetween.

3. Apparatus according to claim 1, wherein the first (8) and second (10) planar seals are configured to form a watertight seal over openings between 0.01 and 100 mm in diameter.

4. Apparatus according to claim 1, wherein the plug element (4 and 6), rigid planar clamping element (12), and cap element (14) are each one made from metal or recyclable plastic.

5. Apparatus according to claim 1, wherein the cap element (14) is a protective cap element and is configured to cover the end of the threaded shaft.

6. Apparatus according to claim 1, wherein the cap element (14) has rounded edges.

7. Apparatus according to claim 1, wherein the first (8) planar sealing element and second (10) planar sealing element are made out of either rubber or silicone.

8. A method of using the apparatus of claim 1 for sealing a hole or tear in a wall or lining, the method comprising the following steps in the following order:
a. inserting the threaded shaft through the opening of the first planar sealing element;
b. inserting the threaded shaft through compromised wall or lining;
c. inserting the threaded shaft through the opening of the second planar sealing element;
d. inserting the threaded shaft through the opening of the rigid planar clamping element;
e. screwing the cap element having the threaded opening onto the threaded shaft to apply pressure on the layers between the planar surface of the plug element and the cap element.

9. Apparatus for sealing a tear in a wall or lining, the apparatus comprising:
a. a plug element in the form of a planar cover (4) having a shaft (6) extending from a first surface in a direction normal to the first surface;
b. a first planar sealing element (8) having an opening configured to receive the shaft;
c. a second planar sealing element (10) having an opening configured to receive the shaft.
d. a rigid planar clamping element (12) having an opening configured to receive the shaft; and
e. a cap element (14) having an opening configured to receive the shaft;
f. wherein the apparatus further comprises a mechanism for tightening and securing the cap element in position on the shaft, thereby causing the planar cover and the rigid planar clamping element to apply force to the first and second sealing elements to form a watertight seal.

10. Apparatus according to claim (9), wherein the mechanism is a snap fitting.
